(19) United States
(12) Patent Application Publication
(10) Pub. No.: US 2018/0200829 A1
(43) Pub. Date: Jul. 19, 2018

(54) FRICTION STIR WELDING FOR COMPACT PARTS

(71) Applicant: Hamilton Sundstrand Corporation, Charlotte, NC (US)

(72) Inventors: Kris H. Campbell, Poplar Grove, IL (US); Mark W. Metzler, Davis, IL (US); Eric A. Carter, Monroe, WI (US); Anthony L. Biermann, Beloit, WI (US); John Horowy, Rockford, IL (US); Eric Karlen, Rockford, IL (US); Debabrata Pal, Hoffman Estates, IL (US)

(21) Appl. No.: 15/410,135

(22) Filed: Jan. 19, 2017

(51) Int. Cl. B23K 20/12; F16B 5/08

(52) U.S. Cl. CPC B23K 20/122; F16B 5/08

(57) ABSTRACT

A friction stir welded component includes a channel body having a main surface and an elongated channel formed in the main surface. The elongated channel has a first depth portion that is longitudinally spanned by shoulders having a second depth, the second depth being shallower than the first depth. The body further has an abutting face that connects the main surface with one of the shoulders at an oblique angle relative to the main surface. A channel cover with an abutting face is seated against the abutting face of the channel body. A friction stir weld joint joins the channel cover to the channel body, wherein the friction stir weld joint is defined along abutting faces of the channel body and channel cover.

### BACKGROUND OF THE INVENTION

### 1. Field of the Invention

The present disclosure relates to joining components, and more particularly to joining components with friction stir welding.

### 2. Description of Related Art

During conventional friction-stir welding (FSW), space must be added at joints to provide adequate support for the downward force applied during the friction stir welding process. The traditional way to counteract this force is by incorporating a shoulder in one part that the other part joins into. This has traditionally been a limiting factor in design, e.g., limiting how compact a component can be designed and still be joinable using friction stir welding.

The conventional techniques have been considered satisfactory for their intended purpose. However, there is an ever present need for improved joining techniques, including improved friction stir welding techniques. This disclosure provides a solution for this problem.

### SUMMARY OF THE INVENTION

A friction stir welded component includes a channel body having a main surface and an elongated channel formed in the main surface. The elongated channel has a first depth portion that is longitudinally spanned by shoulders having a second depth, the second depth being shallower than the first depth. The body further has an abutting face that connects the main surface with one of the shoulders at an oblique angle relative to the main surface. A channel cover with an abutting face is seated against the abutting face of the channel body. A friction stir weld joint joins the channel cover to the channel body, wherein the friction stir weld joint is defined along abutting faces of the channel body and channel cover.

The friction stir weld joint can be a first friction stir weld joint and the abutting face of the channel body can be a first abutting face of the channel body. A second abutting face can be alongside the elongated channel opposite the first abutting face, wherein the channel cover is seated against both the first abutting face and the second abutting face. A second friction stir weld joint can join the channel cover to the channel body, wherein the second friction stir weld joint is defined along the second abutting face of the channel body and an abutting face of the channel cover that are angled obliquely relative to the main surface of the channel body opposite the first friction stir weld joint across the elongated channel. The first and second friction stir welds can be defined along oblique abutting faces that converge towards each other as a function of greater depth from the main surface of the channel body.

A portion of a shoulder surface of the shoulder can be free of friction stir weld blowout between the friction stir weld joint and the elongated channel. The portion of the shoulder surface free of friction stir weld blowout can be smaller in cross-sectional width than the friction stir weld joint along the shoulder surface. The friction stir weld joint can define a blowout feature within the friction stir weld joint that is off-center with respect to the friction stir weld joint. A fluid passage can be defined by the elongated channel via seals created between the channel cover and the channel body by first and second friction stir weld joints, and the fluid passage can define a portion of a cooling plate cooling channel system. The channel can include lengthwise heat transfer fins defined therethrough.

A method of friction stir welding includes seating a channel cover toward an abutting face that connects a main surface of a channel body to a shoulder surface that is inward from the main surface so that the channel cover covers over a channel having a channel bottom surface defined at a depth from the main surface of the channel body to a deeper depth than that of the shoulder surface from the main surface, wherein the shoulder surface runs along the channel. The method includes friction stir welding the channel cover to the channel body to form a friction stir weld joint along abutting faces of the channel cover and the channel body, wherein the abutting faces are angled obliquely with respect to the main surface of the channel body.

The friction stir weld joint can be a first friction stir weld joint and the shoulder surface can be a first shoulder surface and the method can include seating the channel cover against a second abutting face of the channel body alongside the channel opposite the first abutting face of the channel body, wherein the channel cover is seated against both the first abutting face and the second abutting face; wherein friction stir welding the channel cover to the channel body includes forming a second friction stir weld joint joining the channel cover to the channel body, wherein the second friction stir weld joint is defined along abutting faces of the channel body and channel cover that are angled obliquely relative to the main surface of the channel body opposite the first friction stir weld joint across the channel. Friction stir welding the channel cover to the channel body can include forming the first and second friction stir welds along oblique abutting faces that converge towards each other as a function of greater depth from the main surface of the channel body.

Friction stir welding the channel cover to the channel body can include keeping a portion of the shoulder surface free of friction stir weld blowout between the friction stir weld joint and the channel, wherein the portion of the shoulder free of friction stir weld blowout is smaller in cross-sectional width than the friction stir weld joint along the shoulder surface. Friction stir welding the channel cover to the channel body can include forming a blowout feature within the friction stir weld joint that is off-center with respect to the friction stir weld joint. Seating the channel cover can include defining the channel between the channel body and the channel cover to form a portion of a cooling plate cooling channel system. The method can include forming the channel lengthwise heat transfer fins defined through the channel. It is also contemplated that the method can include clamping the channel cover against the abutting surface to hold the channel cover and channel body together during friction stir welding.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded perspective view of an exemplary embodiment of a friction stir welded component constructed in accordance with the present disclosure, showing the channel body and channel cover separated from one another, as before friction stir welding them together; and

FIG. 2 is a schematic cross-sectional end elevation view of the component of FIG. 1, showing the friction stir weld joints joining the channel cover to the channel body.

### DETAILED DESCRIPTION OF THE PREFERRED EMBODIMENTS

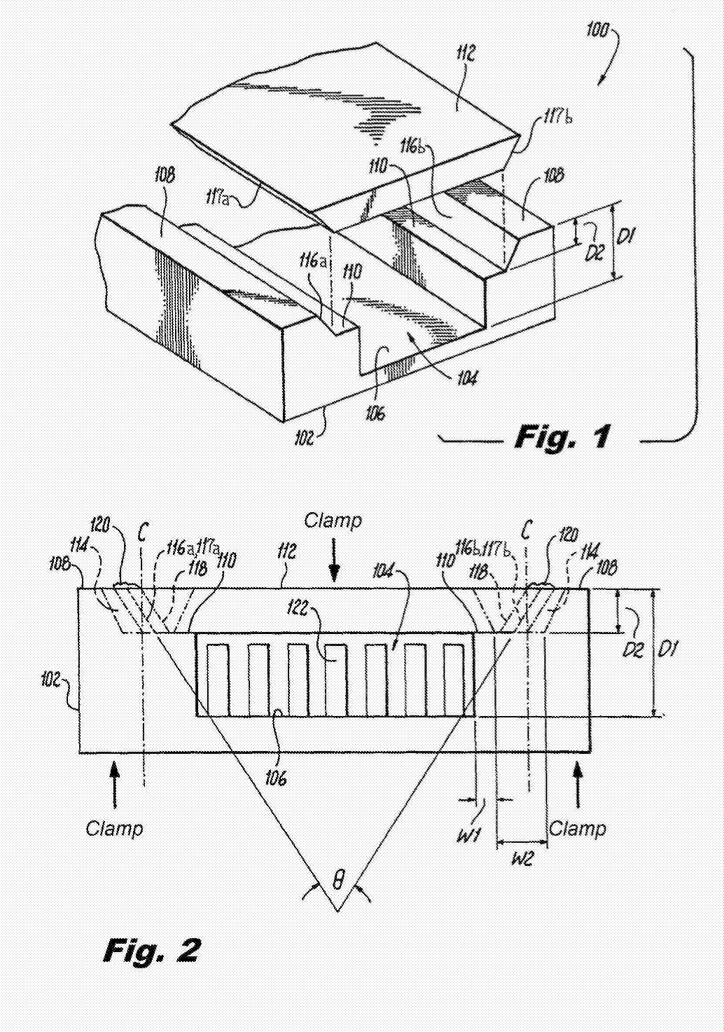

Reference will now be made to the drawings wherein like reference numerals identify similar structural features or aspects of the subject disclosure. For purposes of explanation and illustration, and not limitation, a partial view of an exemplary embodiment of a friction stir welded component in accordance with the disclosure is shown in FIG. 1 and is designated generally by reference character 100. Other embodiments of components in accordance with the disclosure, or aspects thereof, are provided in FIG. 2, as will be described. The systems and methods described herein can be used to provide compact friction stir welded components such as friction stir welded cold plates for cooling electrical components or the like.

Component 100 includes a channel body 102 defining a channel 104 therein with a bottom channel surface 106 set into the channel body 102 from a main surface 108 of the channel body 102 to a first depth D1. An opposed pair of shoulder surfaces 110 is included running alongside the channel 104. The shoulder surfaces 110 are set into the channel body 102 to a second depth D2 shallower than the first depth D1 from the main surface 108. A channel cover 112 is seated against abutting faces 116a, 116b of the channel body 102, as shown in FIG. 2. The abutting faces 116a, 116b of channel body 102 are angled between the main surface 108 and the respective shoulder surfaces 110. The corresponding abutting faces 117a, 117b of channel cover 112 are angled between the upper and lower surfaces of channel cover 112 as oriented in FIG. 2, and the angles of abutting faces 117a, 117b of the channel cover 112 are the same as those of the respective abutting faces 116a, 116b of channel body 102. A respective friction stir weld joint 114 joins the channel cover 112 to the channel body 102 along the joint between each engaged pair of abutting surfaces 116a/117a and 116b/117b, e.g., in a direction following along each of the respective shoulder surfaces 110. Each friction stir weld joint 114 is defined along abutting faces 116a, 116b, 117a, 117b of the channel body 102 and channel cover 112 that are angled obliquely relative to the main surface 108 of the channel body 102 and that run along the shoulder surfaces 110. The first and second friction stir welds 114 are defined along oblique abutting faces 116a, 116b, 117a, 117b that converge towards each other as a function of greater depth from the main surface 108 of the channel body 106, as indicated in FIG. 2 by angle θ, which can be any suitable angle for a given application, e.g., 20-160°.

A portion of the shoulder surfaces 110 is free of friction stir weld blowout between the respective friction stir weld joint 114 and the channel 104. This blowout free portion is indicated in FIG. 2 by width W1. That portion of the shoulder 110 that is free of friction stir weld blowout is smaller in cross-sectional width than the friction stir weld joint 114 along the shoulder surface 110, i.e., W2 is greater than W1 in FIG. 2. The friction stir weld joint 114 can define a blowout feature 118 within each friction stir weld joint 114 that is off-center with respect to the friction stir weld joint 114, e.g., deviates from center line C and/or is oblique with respect to the main surface 108. Blowout 120 can be removed from a final component 100, however, an artifact of blowout feature 118 will be evident metallurgically within the remaining friction stir weld joints 114. The channel 104 is sealed by friction stir weld joints 114 and can define a portion of a cooling plate cooling channel system. The channel can optionally include lengthwise heat transfer fins 122 defined therethrough. These fins can be flat plate fins, corrugated, pin or lanced offset or any other suitable features to provide increased rate of heat transfer.

A method of friction stir welding includes seating a channel cover, e.g., channel cover 112, toward a shoulder surface, e.g., shoulder surface 110, defined inward from a main surface, e.g., main surface 108, of a channel body, e.g., channel body 102. The channel cover covers over a channel, e.g., channel 104, having a channel bottom surface, e.g., channel bottom surface 106, defined inward from the main surface of the channel body to a deeper depth than that of the shoulder surface from the main surface. The shoulder surface runs along the channel. The method also includes friction stir welding the channel cover to the channel body to form a friction stir weld joint along abutting faces of the channel cover and the channel body, wherein the abutting faces are angled obliquely with respect to the main surface of the channel body. Forming the friction stir welds along oblique abutting surfaces, e.g., surfaces 116a, 116b, 117a, 117b, reduces the amount of shoulder needed compared to traditional techniques, to allow for more compact components, e.g., the width of component 100 in FIG. 2 can be smaller because the shoulder width required is less than it would be with traditional techniques. It is also contemplated that the method can include clamping the channel cover against or toward the shoulder surface, as indicated by the larger opposed arrows in FIG. 2, to hold the channel cover and channel body together during friction stir welding because the oblique abutting surfaces, e.g., surfaces 116, can counteract some of the friction stir welding forces. Since the channel cover can be wedged into channel body 102, the tolerances for the abutting surfaces, e.g., surfaces 116a, 116b, 117a, 117b, can be relaxed relative to in traditional techniques, and any needed gaps between the channel cover and channel body can be reduced relative to what is required in traditional techniques. Techniques as disclosed herein can also reduce the number of tack welds needed before friction stir welding to hold the channel cover and channel body together compared to traditional techniques.

It is contemplated that the channel width need not necessarily be constant along the length of flow. The channel, e.g., channel 104, can have three length-wise zones, wherein in the first and third zones, there may not be any fins. These zones can have a narrow channel width, for example. The middle, or the second zone of the channel may have wider channel for incorporating fins to match the heat source width, for example. A heat source can be mounted on the cold plate, e.g., on the same side of the cold plate as the fins but outside the flow channel.

The methods and systems of the present disclosure, as described above and shown in the drawings, provide for friction stir welding with superior properties including relaxed tolerances and more compact finished parts compared to traditional techniques. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A friction stir welded component comprising:
a channel body having a main surface and an elongated channel formed in the main surface, the elongated channel having a first depth portion that is longitudinally spanned by shoulders having a second depth, the second depth being shallower than the first depth, the body further having an abutting face that connects the main surface with one of the shoulders at an oblique angle relative to the main surface;
a channel cover with an abutting face seated against the abutting face of the channel body; and
a friction stir weld joint joining the channel cover to the channel body, wherein the friction stir weld joint is defined along abutting faces of the channel body and channel cover.

2. The friction stir welded component as recited in claim 1, wherein the friction stir weld joint is a first friction stir weld joint and the abutting face of the channel body is a first abutting face of the channel body and further comprising:
a second abutting face alongside the elongated channel opposite the first abutting face, wherein the channel cover is seated against both the first abutting face and the second abutting face; and
a second friction stir weld joint joining the channel cover to the channel body, wherein the second friction stir weld joint is defined along the second abutting face of the channel body and an abutting face of the channel cover that are angled obliquely relative to the main surface of the channel body opposite the first friction stir weld joint across the elongated channel.

3. The friction stir welded component as recited in claim 2, wherein the first and second friction stir welds are defined along oblique abutting faces that converge towards each other as a function of greater depth from the main surface of the channel body.

4. The friction stir welded component as recited in claim 1, wherein a portion of a shoulder surface of the shoulder is free of friction stir weld blowout between the friction stir weld joint and the elongated channel, and wherein the portion of the shoulder surface free of friction stir weld blowout is smaller in cross-sectional width than the friction stir weld joint along the shoulder surface.

5. The friction stir welded component as recited in claim 1, wherein the friction stir weld joint defines a blowout feature within the friction stir weld joint that is off-center with respect to the friction stir weld joint.

6. The friction stir welded component as recited in claim 2, wherein a fluid passage is defined by the elongated channel via seals created between the channel cover and the channel body by first and second friction stir weld joints, the fluid passage defining a portion of a cooling plate cooling channel system.

7. The friction stir welded component as recited in claim 6, wherein the channel includes lengthwise heat transfer fins defined therethrough.

8. A method of friction stir welding comprising:
seating a channel cover toward an abutting face that connects a main surface of a channel body to a shoulder surface that is inward from the main surface so that the channel cover covers over a channel having a channel bottom surface defined at a depth from the main surface of the channel body to a deeper depth than that of the shoulder surface from the main surface, wherein the shoulder surface runs along the channel; and
friction stir welding the channel cover to the channel body to form a friction stir weld joint along abutting faces of the channel cover and the channel body, wherein the abutting faces are angled obliquely with respect to the main surface of the channel body.

9. The method as recited in claim 8, wherein the friction stir weld joint is a first friction stir weld joint and the shoulder surface is a first shoulder surface and further comprising:
seating the channel cover against a second abutting surface running along the second shoulder surface alongside the channel opposite the first shoulder surface, wherein the channel cover is seated against both the first abutting surface and the second abutting surface; and
wherein friction stir welding the channel cover to the channel body includes forming a second friction stir weld joint joining the channel cover to the channel body, wherein the second friction stir weld joint is defined along abutting faces of the channel body and channel cover that are angled obliquely relative to the main surface of the channel body opposite the first friction stir weld joint across the channel.

10. The method as recited in claim 9, wherein friction stir welding the channel cover to the channel body includes forming the first and second friction stir welds along oblique abutting faces that converge towards each other as a function of greater depth from the main surface of the channel body.

11. The method as recited in claim 8, wherein friction stir welding the channel cover to the channel body includes keeping a portion of the shoulder surface free of friction stir weld blowout between the friction stir weld joint and the channel, wherein the portion of the shoulder free of friction stir weld blowout is smaller in cross-sectional width than the friction stir weld joint along the shoulder surface.

12. The method as recited in claim 8, wherein friction stir welding the channel cover to the channel body includes forming a blowout feature within the friction stir weld joint that is off-center with respect to the friction stir weld joint.

13. The method as recited in claim 8, wherein seating the channel cover includes defining the channel between the channel body and the channel cover to form a portion of a cooling plate cooling channel system.

14. The method as recited in claim 13, further comprising forming the channel lengthwise heat transfer fins defined through the channel.

15. The method as recited in claim 8, further comprising clamping the channel cover against the abutting surface to hold the channel cover and channel body together during friction stir welding.
